(19) United States
(12) Patent Application Publication
(10) Pub. No.: US 2025/0080855 A1
(43) Pub. Date: Mar. 6, 2025

(54) CONTROL APPARATUS, CONTROL METHOD, AND COMPUTER READABLE MEDIUM

(71) Applicant: NEC Corporation, Minato-ku, Tokyo (JP)

(72) Inventor: Yuta SHIMIZU, Tokyo (JP)

(73) Assignee: NEC Corporation, Minato-ku, Tokyo (JP)

(21) Appl. No.: 18/728,438

(22) PCT Filed: Mar. 25, 2022
(86) PCT No.: PCT/JP2022/014442

§ 371 Date: Jul. 11, 2024

(51) Int. Cl. H04N 23/70; G06V 10/60; G06V 10/75; G06V 40/16; H04N 23/611

(52) U.S. Cl. CPC H04N 23/70; G06V 10/60; G06V 10/751; G06V 40/161; H04N 23/611; G06V 2201/07

(57) ABSTRACT

A control apparatus capable of reducing the processing time is provided. An image acquisition unit acquires an image obtained by photographing a surrounding environment. A detection unit performs a process for detecting a detection target from the acquired image. A calculation unit calculates brightness by using some of pixels in an area of the detection target detected from the image, specified under a predetermined condition. A determination unit determines a control parameter used in a photographing apparatus based on the calculated brightness. A control unit controls the photographing apparatus so as to perform photographing by using the determined control parameter.

### TECHNICAL FIELD

The present disclosure relates to a control apparatus, a control method, and a computer readable medium.

### BACKGROUND ART

Patent Literature 1 discloses a face authentication apparatus. The face authentication apparatus disclosed in Patent Literature 1 acquires images of the face of a person taken from different directions by using one high tone-level camera and a plurality of low tone-level cameras, and detects a face area from a high tone-level input image acquired by the high tone-level camera. Further, the face authentication apparatus disclosed in Patent Literature 1 performs brightness control (gain control and the like) of the other low tone-level cameras based on the distribution of pixel values of the detected face area, and after the brightness control is performed, detects the face areas from low tone-level input images acquired by the low tone-level cameras. Further, the face authentication apparatus disclosed in Patent Literature 1 selects, from among an image of the face area obtained from the high tone-level input image and images of the face areas obtained from the low tone-level input images, an image of the face area having the highest evaluation value, and performs face matching process with the selected image of the face area. Further, the face authentication apparatus according to Patent Literature 1 obtains the distribution of pixel values of the face area in the brightness control, transmits a brightness control signal generated based on the obtained distribution of pixel values to the low tone-level cameras, and thereby perform brightness control of the low tone-level cameras in regard to the photographing conditions such as a gain, a shutter speed, and an aperture.

### CITATION LIST

### Patent Literature

Patent Literature 1: Japanese Unexamined Patent Application Publication No. 2009-134593

### SUMMARY OF INVENTION

### Technical Problem

In the technology disclosed in Patent Literature 1, brightness is controlled by using the pixels of the entire face area which is the area to be detected (hereinafter also referred to as the detection target). When brightness is controlled by using the pixels of the entire area of the detection target (target object), the processing time may increase. In particular, when the size of the detection target, such as a face, in the image is large, the processing time increases.

An object of the present disclosure is to provide a control apparatus, a control method, and a program capable of reducing the processing time.

### Solution to Problem

A control apparatus according to the present disclosure includes: image acquisition means for acquiring an image obtained by photographing a surrounding environment; detection means for performing a process for detecting a detection target from the acquired image; calculation means for calculating brightness by using some of pixels in an area of the detection target detected from the image, specified under a predetermined condition; determination means for determining a control parameter used in a photographing apparatus based on the calculated brightness; and control means for controlling the photographing apparatus so as to perform photographing by using the determined control parameter.

Further, a control method according to the present disclosure includes: acquiring an image obtained by photographing a surrounding environment; performing a process for detecting a detection target from the acquired image; calculating brightness by using some of pixels in an area of the detection target detected from the image, specified under a predetermined condition; determining a control parameter used in a photographing apparatus based on the calculated brightness; and controlling the photographing apparatus so as to perform photographing by using the determined control parameter.

Further, a program according to the present disclosure causes a computer to perform: a step of acquiring an image obtained by photographing a surrounding environment; a step of performing a process for detecting a detection target from the acquired image; a step of calculating brightness by using some of pixels in an area of the detection target detected from the image, specified under a predetermined condition; a step of determining a control parameter used in a photographing apparatus based on the calculated brightness; and a step of controlling the photographing apparatus so as to perform photographing by using the determined control parameter.

### Advantageous Effects of Invention

According to the present disclosure, it is possible to provide a control apparatus, a control method, and a program capable of reducing the processing time.

### BRIEF DESCRIPTION OF DRAWINGS

FIG. 1 shows an overview of a control apparatus according to an example embodiment;

FIG. 2 is a flowchart showing an overview of a control method performed by the control apparatus according to the example embodiment;

FIG. 3 shows a configuration of a control system according to a first example embodiment;

FIG. 4 shows a configuration of a control apparatus according to the first example embodiment;

FIG. 5 is a flowchart showing a control method performed by the control apparatus according to the first example embodiment;

FIG. 6 is a diagram for explaining processes performed by a detection unit according to the first example embodiment;

FIG. 7 is a flowchart showing a first modified example of processes performed by a brightness calculation unit according to the first example embodiment;

FIG. 8 is a flowchart showing a second modified example of processes performed by the brightness calculation unit according to the first example embodiment;

FIG. 9 is a flowchart showing a control method performed by a control apparatus according to a second example embodiment;

FIG. 10 is a flowchart showing a control method performed by a control apparatus according to a third example embodiment; and

FIG. 11 is a flowchart showing a control method performed by a control apparatus according to a fourth example embodiment.

### EXAMPLE EMBODIMENT

### Overview of Example Embodiment

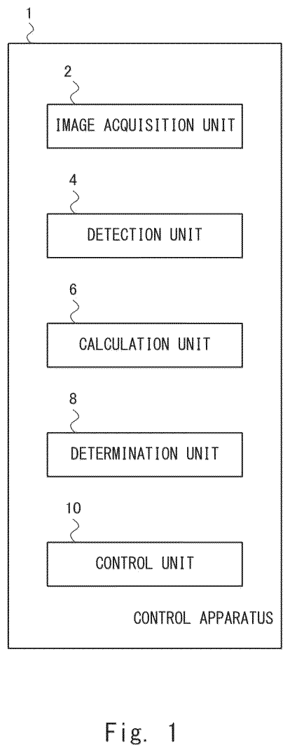

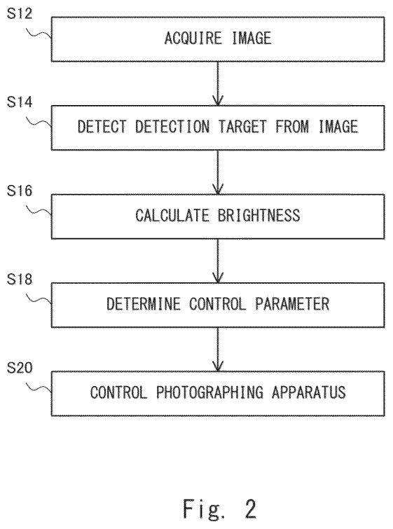

Prior to describing an example embodiment, an overview of the example embodiment will be described. FIG. 1 shows an overview of a control apparatus 1 according to an example embodiment. Further, FIG. 2 is a flowchart showing an overview of a control method performed by the control apparatus according to the example embodiment.

The control apparatus 1 is, for example, a computer. The control apparatus 1 includes an image acquisition unit 2, a detection unit 4, a calculation unit 6, a determination unit 8, and a control unit 10. The image acquisition unit 2 functions as image acquisition means. The detection unit 4 functions as detection means. The calculation unit 6 functions as calculation means. The determination unit 8 functions as determination means. The control unit 10 functions as control means.

The image acquisition unit 2 acquires an image obtained by photographing a surrounding environment (i.e., an environment around the image acquisition unit 2) (Step S12). The image can be taken by a photographing apparatus (which will be described later). Note that the image may be a moving image (video image) or may be a still image. Further, the image may be a frame image constituting a video image. Further, in the following description, the term “image” means “image data representing an image” which is an object to be processed in information processing.

The detection unit 4 performs a process for detecting a detection target (i.e., an object to be detected) from an acquired image (Step S14). The detection target is, for example, the face of a person, but is not limited to this example. The detection target may be an arbitrary object. The detection target may be the entire body of a person. Alternatively, the detection target may be a non-human mobile object, or may be a structure. Further, the detection unit 4 may detect at least one feature point characterizing the detection target in the area of the detection target on the image.

The calculation unit 6 calculates brightness by using some of pixels in the area of the detection target detected from the image, specified under a predetermined condition(s) (Step S16). Therefore, the calculation unit 6 does not calculate brightness by using all the pixels in the area of the detection target. Note that examples of “predetermined conditions” will be described later.

Note that the calculation unit 6 may calculate brightness by using pixels in the area of the detection target, corresponding to at least one feature point characterizing the detection target. Further, when a part of the detection target is shielded (i.e., hidden or covered), the calculation unit 6 may calculate brightness by using pixels corresponding to a feature point(s) other than a feature point(s) located in the shielded part. Further, when a part of the detection target is shielded, the calculation unit 6 may calculate brightness by reducing the weights of pixels corresponding to a feature point(s) located in the shielded part and then calculating a weighted average of pixel values of pixels corresponding to the feature points (i.e., all the feature points). Further, the calculation unit 6 may calculate brightness by preferentially using pixels corresponding to feature points for parts of the detection target having a high priority over pixels corresponding to feature points for parts thereof having a low priority. Note that these priorities are set for parts of the detection target in advance. Note that in the case where the detection target is, for example, a face, parts constituting the detection target are eyes, a nose, a mouth, eyebrows, and the like.

Further, the calculation unit 6 may calculate brightness by using pixels of unshielded areas (i.e., areas that are not hidden) included in the area of the detection target. Further, the calculation unit 6 may calculate brightness by using pixels located at predetermined intervals in the area of the detection target. Further, the calculation unit 6 may calculate brightness by using pixels in the area of the detection target, corresponding to at least one part constituting the detection target.

The determination unit 8 determines a control parameter(s) used in a photographing apparatus based on the calculated brightness (Step S18). The control unit 10 controls the photographing apparatus so as to perform photographing by using the determined control parameter(s) (Step S20). The photographing apparatus is, for example, a camera, but is not limited to this example. Further, examples of “control parameters” include an exposure time and a gain, but are not limited to these examples.

As described above, in this example embodiment, brightness is calculated by using some of pixels in the area of the detection target detected from the image, specified under a predetermined condition(s). That is, the brightness is not calculated by using all the pixels in the area of the detection target, but is calculated by using some of the pixels obtained by thinning out the pixels. Therefore, in this example embodiment, it is possible to reduce the processing time compared with the case where brightness is calculated by using all the pixels in the area of the detection target. Note that the processing time can also be reduced by a program for performing the above-described control method.

### First Example Embodiment

An example embodiment will be described hereinafter with reference to the drawings. To clarify the description, the following description and drawings are partly omitted and simplified as appropriate. Further, the same elements are assigned the same reference numerals (or symbols) throughout the drawings, and redundant descriptions thereof are omitted as appropriate.

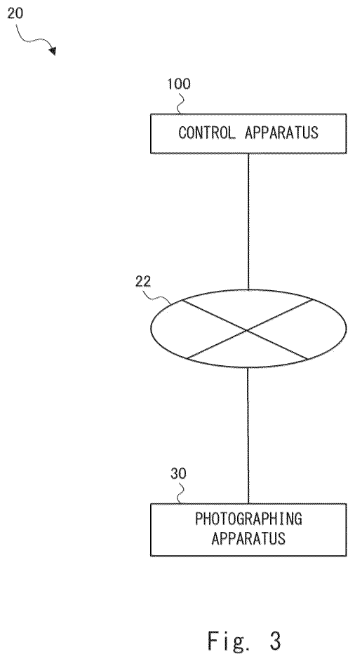

FIG. 3 shows a configuration of a control system 20 according to a first example embodiment. The control system 20 includes a photographing apparatus 30 and a control apparatus 100. The control apparatus 100 is connected to the photographing apparatus 30 through a wired or wireless network 22. The network 22 is, for example, a LAN (Local Area Network) or the Internet.

The photographing apparatus 30 is, for example, a camera. The photographing apparatus 30 photographs a surrounding environment. The photographing apparatus 30 may be installed in, for example, a vehicle such as a passenger car. In this case, the photographing apparatus 30 may photograph an environment outside (or inside) the vehicle.

The control apparatus 100 corresponds to the control apparatus 1 shown in FIG. 1. The control apparatus 100 receives an image from the photographing apparatus 30 and thereby acquires the image. The control apparatus 100 detects a detection target (i.e., an object to be detected) from the image, and calculates brightness by using some of pixels in the area of the detected detection target, specified under a predetermined condition(s). Further, the control apparatus 100 determines a control parameter(s) used in the photographing apparatus 30 based on the calculated brightness, and controls the photographing apparatus 30 so as to perform photographing by using the determined control parameter(s). Details of these processes will be described later.

Note that in the first example embodiment, the face of a person is detected as the detection target, but the detection target is not limited to the face of a person. Further, the control apparatus 100 may perform face authentication by using an image of face (hereinafter also referred to as a face image) detected from an image acquired from the photographing apparatus 30. For example, the photographing apparatus 30 capable of photographing the outside of a vehicle photographs a person present near the vehicle. The control apparatus 100 detects the face of the person from an image obtained by the photographing, and performs face authentication by comparing the detected face image with a face image of the owner (e.g., a driver or the like) of the vehicle. The control apparatus 100 may unlock the vehicle when the face authentication has succeeded.

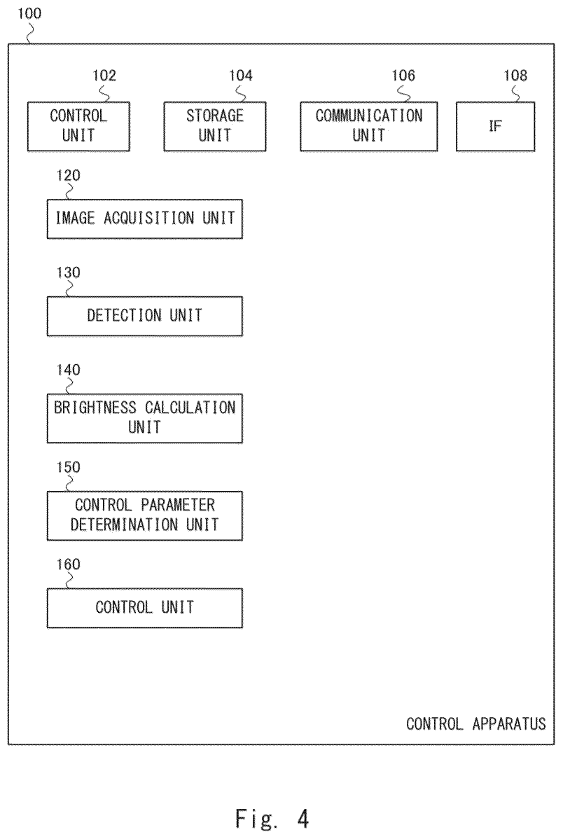

FIG. 4 shows a configuration of the control apparatus 100 according to the first example embodiment. As shown in FIG. 4, the control apparatus 100 includes, as its main hardware configuration, a control unit 102, a storage unit 104, a communication unit 106, and an interface (IF; Interface) unit 108. The control unit 102, the storage unit 104, the communication unit 106, and the interface unit 108 are connected to each other through a data bus and the like. Note that the photographing apparatus 30 may also have a hardware configuration identical to that of the control apparatus 100 shown in FIG. 4.

The control unit 102 may be a processor such as a CPU (Central Processing Unit). The control unit 102 functions as an arithmetic apparatus that performs control processing, arithmetic processing, and the like. Note that the control unit 102 may include a plurality of processors. The storage unit 104 may be a storage device such as a memory or a hard disk drive. The storage unit 104 may be, for example, a ROM (Read Only Memory) or a RAM (Random Access Memory). The storage unit 104 has a function of storing a control program, an arithmetic program, and the like executed by the control unit 102. That is, the storage unit 104 (memory) stores at least one instruction. Further, the storage unit 104 has a function of temporarily storing processing data and the like. The storage unit 104 may include a database. Further, the storage unit 104 may include a plurality of memories.

The communication unit 106 performs processing necessary to communicate with other apparatuses such as the photographing apparatus 30 through the network. The communication unit 106 may include communication ports, a router, a firewall, and the like. The interface (IF; Interface) unit 108 is, for example, a user interface (UI). The interface unit 108 includes an input device such as a keyboard, a touch panel, or a mouse, and an output device such as a display device or a speaker. The interface unit 108 may be formed in such a manner that, for example, the input device and the output device are integrated with each other, e.g., formed as a touch screen (touch panel). The interface unit 108 receives an operation for entering data performed by a user (operator) and outputs information for the user. For example, the interface unit 108 may output (display) a determined control parameter(s).

The control apparatus 100 according to the first example embodiment includes, as its components, an image acquisition unit 120, a detection unit 130, a brightness calculation unit 140, a control parameter determination unit 150, and a control unit 160. Note that the control apparatus 100 does not have to be formed as one physical apparatus. In this case, each of the above-described components may be implemented by a plurality of apparatuses physically separated from other.

The image acquisition unit 120 corresponds to the image acquisition unit 2 shown in FIG. 1. The image acquisition unit 120 functions as image acquisition means. The detection unit 130 corresponds to the detection unit 4 shown in FIG. 1. The detection unit 130 functions as detection means. The brightness calculation unit 140 corresponds to the calculation unit 6 shown in FIG. 1. The brightness calculation unit 140 functions as brightness calculation means (calculation means). The control parameter determination unit 150 corresponds to the determination unit 8 shown in FIG. 1. The control parameter determination unit 150 functions as control parameter determination means (determination means). The control unit 160 corresponds to the control unit 160 shown in FIG. 1. The control unit 160 functions as control means.

Note that each of the above-described components can be implemented by, for example, executing a program under the control of the control unit 102. More specifically, each component can be implemented by having the control unit 102 execute a program (instructions) stored in the storage unit 104. Alternatively, each component may be implemented by recording a necessary program on an arbitrary nonvolatile recording medium in advance and installing the program as required. Further, the implementation of each component is not limited to the software implementation using a program. That is, each component may be implemented by any combination of two or more of hardware, firmware, and software. Further, each component may be implemented by using a user-programmable integrated circuit such as an FPGA (field-programmable gate array) or a microcomputer. In this case, a program for implementing each of the above-described components may be implemented (i.e., executed) by using the above-described integrated circuit. Note that a specific function of each component will be described later.

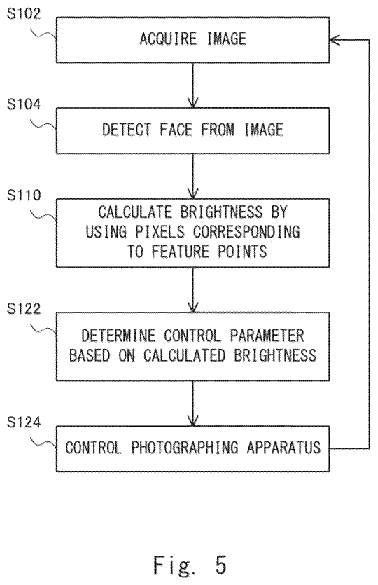

FIG. 5 is a flowchart showing a control method performed by the control apparatus 100 according to the first example embodiment. The image acquisition unit 120 acquires an image (Step S102). Specifically, the image acquisition unit 120 acquires an image transmitted from the photographing apparatus 30 by using the communication unit 106. The image acquisition unit 120 may acquire a frame image every time a frame image is generated by the photographing apparatus 30. Alternatively, in the case where frame images from the photographing apparatus 30 are temporarily stored in the storage unit 104 (buffer), the image acquisition unit 120 may acquire a frame image from the buffer. Note that in the case where the photographing apparatus 30 successively generates still images in a chronological order, the image acquisition unit 120 may acquire a still image.

The detection unit 130 detects a face, which is the detection target (i.e., the object to be detected), from the acquired image (Step S104). Specifically, the detection unit 130 detects an area of a face (e.g., a rectangle including a face image) in the acquired image. Then, the detection unit 130 detects feature points in the detected area of the face (hereinafter also referred to as the face area). Note that the detection unit 130 may detect a feature point (e.g., each of feature points) by determining which of the pixels in the face area corresponds to the feature point set in advance. The feature points are points characterizing the face (detection target). The feature points may be present, for example, at places corresponding to parts characterizing the face. Examples of parts characterizing a face include eyes, a nose, a mouth, eyebrows, and the like. That is, it is defined in advance which of the parts of a face (eyes, a nose, a mouth, eyebrows, and the like) a feature point (e.g., each of feature points) belongs to (i.e., corresponds to).

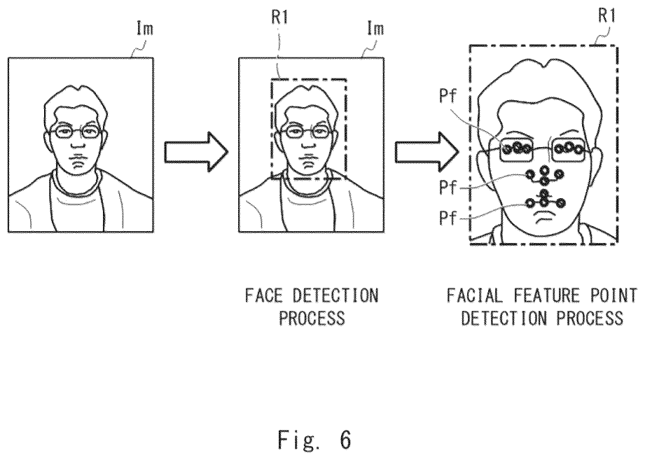

FIG. 6 is a diagram for explaining processes performed by the detection unit 130 according to the first example embodiment. The detection unit 130 performs a face detection process on an acquired image Im, and thereby detects a face area R1, which is a rectangle including a face image, from the image Im. Next, the detection unit 130 performs a facial feature point detection process on the face area R1. In this way, the detection unit 130 detects the positions of facial feature points Pf corresponding to the eyes, the nose, edges of the mouth, and the like. As shown in FIG. 6, at least one feature point Pf may exist at a place corresponding to an eye in the face area R1. Further, at least one feature point Pf may exist at a place corresponding to the nose in the face area R1. Further, at least one feature point Pf may exist at a place corresponding to the mouth in the face area R1. Note that the face detection process and the facial feature point detection process may be performed by using existing technologies.

Note that the detection unit 130 can detect the position of each part of the face (eyes, a nose, a mouth, and the like) by performing the facial feature point detection process. For example, the detection unit 130 may detect, for each of the parts, an area near pixels corresponding to a feature point corresponding to that part as an area of that part. For example, the detection unit 130 may detect an area near pixels corresponding to a feature point corresponding to an eye as an eye area (eye position). Further, the detection unit 130 may perform a face authentication process (matching process) by using the position of each part in the face area. Note that a feature point may correspond to one pixel. Alternatively, a feature point may correspond to a plurality of pixels. Alternatively, a feature point may correspond to all the pixels of an image of a part corresponding thereto.

The brightness calculation unit 140 calculates brightness by using pixels corresponding to a feature point (Step S110). Note that in the first example embodiment, the “predetermined condition” is that pixels corresponding to feature points in the area of the face (detection target) should be used. Specifically, the brightness calculation unit 140 calculates an average value of the pixel values of pixels corresponding to the feature point and pixels therearound as brightness (brightness of the feature point). For example, the brightness calculation unit 140 may calculate an average value of the pixel values of all the feature points, each of which includes nine pixels (pixels corresponding to the feature point) consisting of one pixel corresponding to the feature point and eight pixels adjacent to this one pixel, e.g., eight pixels around this one pixel, as brightness. When the number of feature points is 14 as in the example shown in FIG. 6, the brightness calculation unit 140 may calculate an average value of the pixel values of 9×14 pixels as brightness. Note that when pixels of nearby feature points are adjacent to each other, some of the pixels around these feature points may coincide with each other. In this case, the brightness calculation unit 140 may not use the pixel values of pixels coinciding with those already used for the calculation of brightness for the calculation.

Further, when the image is a grayscale image, a pixel value may be expressed by a value of 0 to 255. Note that when the image is a color image, each of pixel values R, G and B may be expressed by a value of 0 to 255. In this case, the brightness calculation unit 140 may average, for each of pixel values R, G and B, the pixel values of the feature points and pixels therearound, and calculate the root mean square of the obtained average values of pixel values R, G and B, respectively, as brightness. Alternatively, the brightness calculation unit 140 may calculate a value obtained by averaging the pixel values of the feature points and pixels therearound without distinguishing R, G and B from each other as brightness.

The control parameter determination unit 150 determines a control parameter(s) of the photographing apparatus 30 based on the calculated brightness (Step S122). Then, the control unit 160 controls the photographing apparatus 30 so that the photographing apparatus 30 performs photographing by using the determined control parameter(s) (Step S124). As a result, the photographing apparatus 30 performs photographing. Then, the process returns to the step S102, and the processes in the steps S102 to S124 are repeated.

Examples of control parameters include an exposure time (shutter speed), a gain, and an aperture (iris). An example in which an exposure time and a gain are determined as control parameters will be described. Firstly, ideal brightness (brightness of feature points) is set as predetermined brightness. When the calculated brightness is darker than the predetermined brightness, the control parameter determination unit 150 determines that the exposure time should be increased by a predetermined minute time. Then, the control unit 160 controls the photographing apparatus 30, which has been set to perform photographing with the determined exposure time, so that the photographing apparatus 30 performs photographing (S124). Then, the processes in the steps S102 to S110 are performed again. Then, when the calculated brightness is still darker than the predetermined brightness, the control parameter determination unit 150 determines that the exposure time should be further increased by the predetermined minute time. If the length of the exposure time reaches a predetermined upper limit as the above-described series of process is repeated, the control parameter determination unit 150 increases the gain little by little in a manner similar to the adjustment of the length of the exposure time.

As described above, the control apparatus 100 according to the first example embodiment is configured to calculate brightness by using pixels corresponding to feature points. As a result, the number of pixels that are used in the calculation of brightness is reduced compared with the case where brightness is calculated by using all the pixels included in the face area. Therefore, the control apparatus 100 according to the first example embodiment can reduce the processing time required for the process for calculating brightness.

Note that when the size of the face area detected in the image is large because, for example, the face is close to the photographing apparatus 30, the number of pixels included in the face area increases. Therefore, in the case where brightness is calculated by using all the pixels included in the face area, the processing time increases as the size of the face area detected in the image increases. In contrast, a certain number of feature points can be detected irrespective of the size of the face area in the image. Therefore, even when the size of the face area detected in the image is large, the processing time required for the process for calculating brightness may be unchanged, i.e., may be constant. Therefore, even when the size of the face area detected in the image is large, the processing time required for the process for calculating brightness can be reduced. Further, feature points may exist on the face image in the face area. Therefore, by calculating brightness by using pixels corresponding to feature points, it is possible to adjust the control parameter(s) more accurately so that the face becomes brighter in the image.

### Modified Example of First Example Embodiment

In the description of the first example embodiment above, no case where a part of the face is shielded (i.e., hidden or covered) by a mask or the like is mentioned. However, the first example embodiment can also be applied to such a case where a part of the face is shielded by a mask or the like. Such a case will be described hereinafter. Note that in the above-described facial feature point detection process, even when a part for a feature point (e.g., an eye, a nose, a mouth, or the like) is shielded, the feature point corresponding to this part may be detected.

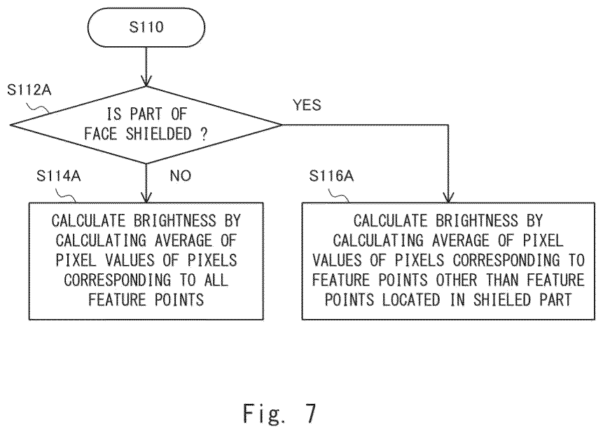

FIG. 7 is a flowchart showing a first modified example of the process (S110) performed by the brightness calculation unit 140 according to the first example embodiment. The brightness calculation unit 140 determines whether or not a part of the face is shielded in the detected face area (Step S112A). The brightness calculation unit 140 determines, for example, whether or not an image of a mask is included in the detected face area. Further, the brightness calculation unit 140 determines, for example, whether or not an image of glasses (or sunglasses) is included in the detected face area. The determination as to whether an image of a mask or glasses is included may be made by using an existing technology. For example, the aforementioned determination may be made by using a machine learning model such as a neural network that has been trained with images of masks or glasses.

When it is determined that no part of the face is shielded (No in S112A), the brightness calculation unit 140 calculates brightness by calculating an average of pixel values of pixels corresponding to all the feature points (Step S114A). Specifically, similarly to the above-described process in the step S110, the brightness calculation unit 140 may calculate an average value of the pixel values of all the feature points, each of which includes nine pixels (pixels corresponding to the feature point) consisting of one pixel corresponding to the feature point and eight pixels adjacent to this one pixel, e.g., eight pixels around this one pixel, as brightness.

On the other hand, when it is determined that a part of the face is shielded (Yes in S112A), the brightness calculation unit 140 calculates brightness by calculating an average of pixel values of pixels corresponding to feature points other than a feature point(s) located in the shielded part (Step S116A). That is, when a part of the face is shielded, the brightness calculation unit 140 calculates brightness by using pixels corresponding to feature points other than the feature point(s) located in the shielded part. In other words, the brightness calculation unit 140 calculates brightness while excluding the feature point(s) located in the shielded part.

For example, when the mouth and the nose are shielded (i.e., hidden or covered) by a mask, the brightness calculation unit 140 calculates brightness by calculating an average of pixel values of pixels corresponding to feature points other than the feature points for the mouth and the nose. In this case, the brightness calculation unit 140 may calculate brightness by using pixels corresponding to the feature points for the eyes and the eyebrows. Further, when the eyebrows are shielded (i.e., hidden) by glasses, the brightness calculation unit 140 calculates brightness by calculating an average of pixel values of pixels corresponding to feature points other than the feature points for the eyebrows. Further, when the eyes are shielded (i.e., hidden) by sunglasses, the brightness calculation unit 140 calculates brightness by calculating an average of pixel values of pixels corresponding to feature points other than the feature points for the eyes.

In the first modified example, as described above, when a part of the face is shielded, brightness is calculated by using pixels corresponding to feature points other than a feature point(s) located in the shielded part, i.e., by excluding the feature point(s) located in the shielded part. Note that since the shielded part is a part of the face area that has not actually been photographed, the pixel values of the pixels located in the shielded part may not reflect the brightness of the face (brightness of the feature point(s)). Therefore, by the above-described configuration, it is possible to adjust the control parameter(s) more accurately so that the face becomes brighter in the image.

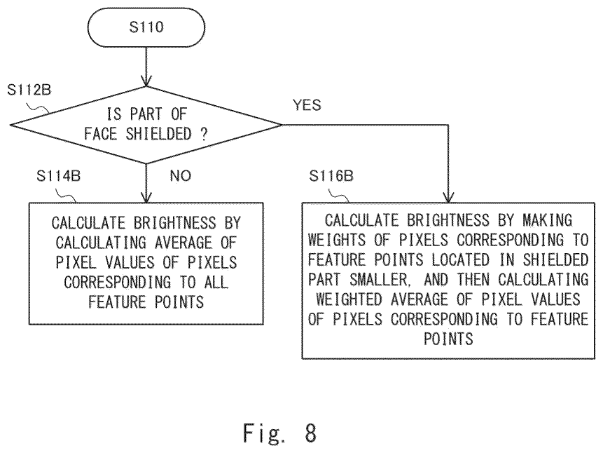

FIG. 8 is a flowchart showing a second modified example of the process (S110) performed by the brightness calculation unit 140 according to the first example embodiment. Similar to the step S112A, the brightness calculation unit 140 determines whether or not a part of the face is shielded in the detected face area (Step S112B). When it is determined that no part of the face is shielded (No in S112B), similarly to the step S114A, the brightness calculation unit 140 calculates brightness by calculating an average of pixel values of pixels corresponding to all the feature points (Step S114B).

On the other hand, when it is determined that a part of the face is shielded (Yes in S112B), the brightness calculation unit 140 reduces the weights of pixels corresponding to a feature point(s) located in the shielded part, and then calculates brightness with the reduced weights. That is, the brightness calculation unit 140 calculates brightness by reducing the weights of pixels corresponding to the feature point(s) located in the shielded part and calculating a weighted average of the pixel values of the pixels corresponding to the feature points (i.e., all the feature points) (Step S116B). In other words, the brightness calculation unit 140 makes the weights of the pixels corresponding to the feature point(s) located in the shielded part smaller than those of the pixels corresponding to the feature points located in the unshielded part. Then, the brightness calculation unit 140 may calculate brightness by calculating a weighted average of the pixel values of the pixels corresponding to the feature points (i.e., all the feature points). That is, in the second modified example, the brightness calculation unit 140 calculates brightness by reducing the weights of the pixels for the feature point(s) located in the shielded part without excluding these feature points.

For example, when the mouth and the nose are shielded (i.e., hidden or covered) by a mask, the brightness calculation unit 140 may calculate brightness by making the weights of pixels corresponding to the feature points for the mouth and the nose smaller than those of pixels corresponding to the feature points for the eyes and the eyebrows, and calculating a weighted average of the pixel values. Further, when the eyebrows are shielded (i.e., hidden) by glasses, the brightness calculation unit 140 may calculate brightness by making the weights of pixels corresponding to the feature points for the eyebrows smaller than those of pixels corresponding to the feature points for the eyes, the nose, and the mouth, and calculating a weighted average of the pixel values. Further, when the eyes are shielded (i.e., hidden) by sunglasses, the brightness calculation unit 140 may calculate brightness by making the weights of pixels corresponding to the feature points for the eyes smaller than those of pixels corresponding to the feature points for the eyebrows, the nose, and the mouth, and calculating a weighted average of the pixel values.

In the second modified example, as described above, when a part of the face is shielded, brightness is calculated by reducing the weights of pixels corresponding to the feature point(s) located in the shielded part, and then calculating a weighted average of the pixel values of pixels corresponding to the feature points (i.e., all the feature points). Note that although the shielded part is a part of the face area that has not actually been photographed, it does not necessarily mean that the pixel values of the pixels located in the shielded part do not reflect the brightness of the face (the brightness of the feature points) at all. Therefore, by the above-described configuration, it is possible to adjust the control parameter(s) more accurately so that the face becomes brighter in the image.

### Second Example Embodiment

Next, a second example embodiment will be described. Note that a configuration of a control system 20 and a control apparatus 100 according to the second example embodiment are substantially the same as that according to the first example embodiment, and therefore the descriptions thereof will be omitted as appropriate. In the second example embodiment, the predetermined condition for specifying some pixels that are used for the calculation of brightness differs from that in the first example embodiment.

Specifically, in the second example embodiment, the “predetermined condition” is that pixels corresponding to feature points for high-priority parts should be preferentially used over pixels corresponding to feature points for low-priority parts. Note that the priority is set for each part in advance.

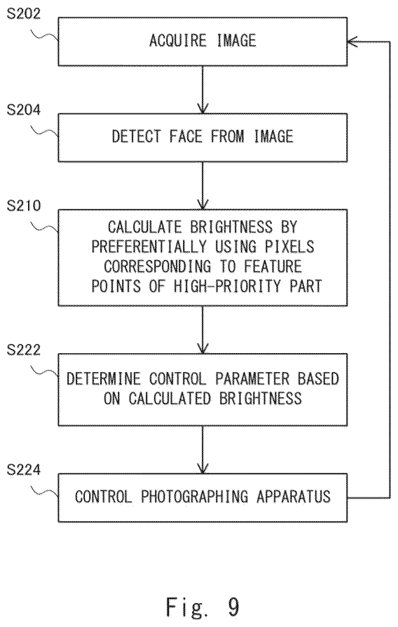

FIG. 9 is a flowchart showing a control method performed by the control apparatus 100 according to the second example embodiment. The image acquisition unit 120 acquires an image in a manner similar to that in the step S102 (Step S202). The detection unit 130 detects a face, which is the detection target, from the acquired image in a manner similar to that in the step S104 (Step S204).

The brightness calculation unit 140 calculates brightness by preferentially using pixels corresponding to feature points of high-priority parts (Step S210). That is, the brightness calculation unit 140 calculates brightness by preferentially using pixels corresponding to feature points for parts of the face (detection target) having a high priority over pixels corresponding to feature points for parts thereof having a low priority. Note that these priorities are set for parts of the face (detection target) in advance.

Assume that, for example, the priority of the mouth is “high”; the priority of the nose is “intermediate”; and the priority of the eyes is “low”. In this case, the brightness calculation unit 140 may calculate brightness by using pixels corresponding to feature points for the mouth and the nose, which are parts other than the eyes having the lowest priority. That is, the brightness calculation unit 140 may calculate brightness by using pixel values of pixels corresponding to feature points for the mouth and the nose by a method substantially the same as the above-described method in the step S110. Note that in the case where there is an upper limit on the number of feature points used for the calculation of brightness, the brightness calculation unit 140 may perform the above-described process when the number of detected feature points reaches or exceeds the upper limit.

Alternatively, the brightness calculation unit 140 may calculate brightness by using pixels corresponding to feature points for the mouth, which has the highest priority. That is, the brightness calculation unit 140 may calculate brightness by using pixel values of pixels corresponding to feature points for the mouth by a method substantially the same as the above-described method in the step S110. Note that in the case where there is an upper limit on the number of feature points used for the calculation of brightness, the brightness calculation unit 140 may perform the above-described process when the number of detected feature points reaches or exceeds the upper limit.

Alternatively, the brightness calculation unit 140 may set, for each part, the weight of pixels corresponding to a feature point(s) corresponding to that part according to the priority, and thereby calculate brightness by calculating a weighted average of the pixel values of the pixels corresponding to the feature points (i.e., all the feature points). That is, the brightness calculation unit 140 may calculate brightness by making the weights of pixels corresponding to feature points for high-priority parts larger than those of pixels corresponding to feature points for low-priority parts, and thereby calculating a weighted average of the pixel values of the pixels corresponding to the feature points (i.e., all the feature points).

Similarly to the step S122, the control parameter determination unit 150 determines a control parameter(s) of the photographing apparatus 30 based on the calculated brightness (Step S222). Then, similarly to the step S124, the control unit 160 controls the photographing apparatus 30 so that the photographing apparatus 30 performs photographing by using the determined control parameter(s) (Step S224). As a result, the photographing apparatus 30 performs photographing. Then, the process returns to the step S202, and the processes in the steps S202 to S224 are repeated.

As described above, the control apparatus 100 according to the second example embodiment is configured to calculate brightness by preferentially using pixels corresponding to feature points for parts of the detection target having a high priority over pixels corresponding to feature points for parts thereof having a low priority. Note that these priorities are set for parts of the detection target in advance. As a result, pixels of feature points for more distinctive parts can be preferentially used. That is, eyes do not greatly differ from one individual to another, so that a low value may be set to the priority of the eyes. Meanwhile, mouths and noses (and eyebrows) greatly differ from one individual to another, so that a high value may be set to the priority of the mouth and the nose (and the eyebrows). In this way, since pixels corresponding to feature points for less distinctive parts are not used, the processing time can be further reduced. Further, by preferentially using pixels of feature points for more distinctive parts, it is possible to adjust a control parameter(s) in such a manner that the more distinctive parts are, the brighter these parts become in the image. Therefore, the control parameter(s) can be adjusted so that the face area becomes brighter in the image.

### Third Example Embodiment

Next, a third example embodiment will be described. Note that a configuration of a control system 20 and a control apparatus 100 according to the third example embodiment are substantially the same as that according to the first example embodiment, and therefore the descriptions thereof will be omitted as appropriate. In the third example embodiment, the predetermined condition for specifying some pixels that are used for the calculation of brightness differs from that in the above-described example embodiments. Specifically, in the third example embodiment, the “predetermined condition” is that pixels in an unshielded area (i.e., an area that is not hidden or covered) should be used.

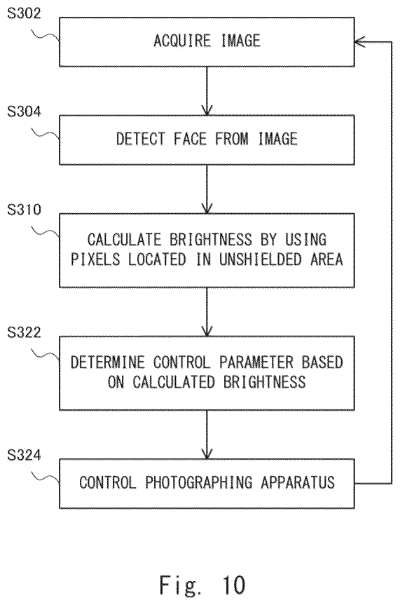

FIG. 10 is a flowchart showing a control method performed by the control apparatus 100 according to the third example embodiment. The image acquisition unit 120 acquires an image in a manner similar to that in the step S102 or the like (Step S302). The detection unit 130 detects a face, which is the detection target, from the acquired image in a manner similar to that in the step S104 or the like (Step S304). Note that in the third example embodiment, the detection unit 130 does not have to detect feature points.

The brightness calculation unit 140 calculates brightness by using pixels in an unshielded area (i.e., an area that is not hidden or covered) (Step S310). Specifically, the brightness calculation unit 140 detects a shielded area (a hidden or covered area) in the face area. For example, as described above, the brightness calculation unit 140 may determine whether or not an image of a mask, glasses (or sunglasses), or the like is included in the detected face area. Then, the brightness calculation unit 140 may regard an image of a mask, glasses (or sunglasses), or the like as a shielded area, and then calculate brightness by using only pixels other than those located in the shielded area in the face area. In this case, the brightness calculation unit 140 may calculate brightness by a method substantially the same as the above-described method in the step S110 by using all the pixels in the unshielded area in the face area. That is, the brightness calculation unit 140 may calculate an average value of pixel values of all the pixels in the unshielded area in the face area as brightness.

Note that when no shielded area is detected, the brightness calculation unit 140 may calculate brightness by using all the pixels in the face area. Alternatively, when no shielded area is detected, the brightness calculation unit 140 may perform the above-described process in the step S110 in the first example embodiment. That is, the brightness calculation unit 140 may calculate brightness by using pixels corresponding to pixels for feature points.

Similarly to the step S122 or the like, the control parameter determination unit 150 determines a control parameter(s) of the photographing apparatus 30 based on the calculated brightness (Step S322). Then, similarly to the step S124 or the like, the control unit 160 controls the photographing apparatus 30 so that the photographing apparatus 30 performs photographing by using the determined control parameter(s) (Step S324). As a result, the photographing apparatus 30 performs photographing. Then, the process returns to the step S302, and the processes in the steps S302 to S324 are repeated.

As described above, the control apparatus 100 according to the third example embodiment is configured to calculate brightness by using pixels in an unshielded area in the area of the detection target (face area). As a result, since brightness is calculated while excluding pixels in the shielded area, the processing time can be reduced compared with the case where brightness is calculated by using all the pixels in the face area. Note that since the shielded part is a part of the face area that has not actually been photographed, the pixel values of the pixels located in the shielded part may not reflect the brightness of the face. Therefore, by the above-described configuration, it is possible to adjust the control parameter(s) more accurately so that the face becomes brighter in the image.

Note that when the shape of the face area is rectangular, the face area may also include a background image around the face image. Therefore, in the third example embodiment, brightness may be calculated by using pixels corresponding to the background image. Therefore, there is a possibility that the control parameter cannot be accurately adjusted so that the face becomes brighter in the image. Meanwhile, as described above, by calculating brightness by using pixels corresponding to feature points as in the first example embodiment, it is possible to adjust the control parameter(s) more accurately so that the face becomes brighter compared with the third example embodiment.

### Fourth Example Embodiment

Next, a fourth example embodiment will be described. Note that a configuration of a control system 20 and a control apparatus 100 according to the fourth example embodiment are substantially the same as that according to the first example embodiment, and therefore the descriptions thereof will be omitted as appropriate. In the fourth example embodiment, the predetermined condition for specifying some pixels that are used for the calculation of brightness differs from that in the above-described example embodiments. Specifically, in the fourth example embodiment, the “predetermined condition” is that pixels located at predetermined intervals should be used.

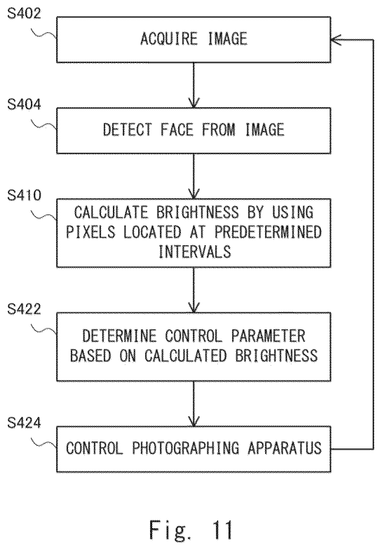

FIG. 11 is a flowchart showing a control method performed by the control apparatus 100 according to the fourth example embodiment. The image acquisition unit 120 acquires an image in a manner similar to that in the step S102 or the like (Step S402). The detection unit 130 detects a face, which is the detection target, from the acquired image in a manner similar to that in the step S104 or the like (Step S404). Note that in the fourth example embodiment, the detection unit 130 does not have to detect feature points.

The brightness calculation unit 140 calculates brightness by using pixels located at predetermined intervals in the face area (Step S410). Specifically, the brightness calculation unit 140 calculates brightness by using, of the pixels in the face area, those located at predetermined intervals. In this case, the brightness calculation unit 140 may calculate brightness by a method substantially the same as the above-described method in the step S110. That is, the brightness calculation unit 140 may calculate an average value of pixel values of pixels located at predetermined intervals in the face area as brightness.

For example, the brightness calculation unit 140 may calculate brightness by using, of the pixels in the face area, those located at predetermined intervals. For example, when it is determined that the interval should be the “length of five pixels” in advance, the brightness calculation unit 140 calculates brightness by using images located at intervals of the length of five pixels. Alternatively, the brightness calculation unit 140 may determine the predetermined interval so that the number of used pixels becomes equal to a predetermined number. Then, the brightness calculation unit 140 may calculate brightness by using the pixels located at the determined predetermined interval.

Similarly to the step S122 or the like, the control parameter determination unit 150 determines a control parameter(s) of the photographing apparatus 30 based on the calculated brightness (Step S322). Then, similarly to the step S124 or the like, the control unit 160 controls the photographing apparatus 30 so that the photographing apparatus 30 performs photographing by using the determined control parameter(s) (Step S324). As a result, the photographing apparatus 30 performs photographing. Then, the process returns to the step S302, and the processes in the steps S302 to S324 are repeated.

As described above, the control apparatus 100 according to the fourth example embodiment is configured to calculate brightness by using pixels located at predetermined intervals in the area of the detection target (face area). As a result, the processing time can be reduced compared with the case where brightness is calculated by using all the pixels in the face area. Further, compared with the above-described example embodiments, some processes such as the detection of feature points or the detection of a shielded area becomes unnecessary, so that the processes can be simplified.

Note that when the shape of the face area is rectangular, the face area may also include a background image around the face image. Therefore, in the fourth example embodiment, brightness may be calculated by using pixels corresponding to the background image. Therefore, there is a possibility that the control parameter cannot be accurately adjusted so that the face becomes brighter in the image. Meanwhile, as described above, by calculating brightness by using pixels corresponding to feature points as in the first example embodiment, it is possible to adjust the control parameter(s) more accurately so that the face becomes brighter compared with the fourth example embodiment.

### Modified Example

Note that embodiments of the present disclosure are not limited to the above-described embodiments, and they can be modified as appropriate without departing from the scope and spirit of the disclosure. For example, the above-described plurality of example embodiments can be applied to each other. Further, for example, the order of processes in the flowchart shown in FIG. 5 and the like can be changed as appropriate. Further, at least one of the processes in the flowcharts shown in FIG. 5 and the like can be omitted.

Further, although the detection target is a face in the above-described example embodiments, the detection target does not have to be a face. The detection target may be an arbitrary object present in the environment. When the detection target is an object other than the face, feature points (key points) may be detected by a technology used in image recognition processing such as SIFT (Scale-Invariant Feature Transform) or SURF (Speeded-Up Robust Features).

Further, although the brightness calculation unit 140 calculates brightness by using pixels in the area of the detection target, corresponding to at least one feature point characterizing the detection target in the first example embodiment and the like, the present disclosure is not limited to this example. The brightness calculation unit 140 may calculate brightness by using pixels in the area of the detection target, corresponding to, instead of feature points, at least one part (a constituent part) constituting the detection target. This constituent part may be a part characterizing the detection target.

In this case, the detection unit 130 may detect the position (area) of the constituent part from the area of the detection target. Further, the brightness calculation unit 140 may calculate brightness by using all (or some) of the pixels corresponding to the constituent part. For example, when the detection target is a face, the constituent parts may be eyes, a nose, a mouth, eyebrows, and the like. The brightness calculation unit 140 may calculate brightness by using pixels corresponding to the eyes, the nose, the mouth, the eyebrows, and the like. Then, the brightness calculation unit 140 may calculate brightness by using all (or some) of pixels corresponding to the eyes, the nose, the mouth, the eyebrows, and the like. By calculating brightness by using pixels corresponding to constituent parts as described above, the number of pixels used in the calculation of brightness decreases compared with the case where brightness is calculated by using all the pixels included in the area of the detection target. Therefore, the processing time can be reduced as in the above-described example embodiments.

However, when the area of the detection target is large relative to the entire image, the size of the area of the above-described part may also increase. Therefore, the larger the size of the area of the detection target detected in the image is, the more the processing time increases. In contrast, as described above, a certain number of feature points can be detected irrespective of the size of the face area in the image. Therefore, by calculating brightness by using pixels corresponding to feature points as in the first example embodiment and the like, it is possible to reduce the processing time required for the process for calculating brightness irrespective of the size of the area of the detection target detected in the image.

The above-described program includes a set of instructions (or software codes) that, when read into a computer, causes the computer to perform one or more of the functions described in the example embodiments. The program may be stored in a non-transitory computer readable medium or in a physical storage medium. By way of example rather than limitation, a computer readable medium or a physical storage medium may include a random-access memory (RAM), a read-only memory (ROM), a flash memory, a solid-state drive (SSD), or other memory technology, a CD-ROM, a digital versatile disk (DVD), a Blu-ray (Registered Trademark) disc or other optical disc storages, a magnetic cassette, magnetic tape, and a magnetic disc storage or other magnetic storage devices. The program may be transmitted on a transitory computer readable medium or a communication medium. By way of example rather than limitation, the transitory computer readable medium or the communication medium may include electrical, optical, acoustic, or other forms of propagating signals.

The whole or part of the example embodiments disclosed above can be described as, but not limited to, the following Supplementary notes.

### (Supplementary Note 1)

A control apparatus comprising:
image acquisition means for acquiring an image obtained by photographing a surrounding environment;
detection means for performing a process for detecting a detection target from the acquired image;
calculation means for calculating brightness by using some of pixels in an area of the detection target detected from the image, specified under a predetermined condition;
determination means for determining a control parameter used in a photographing apparatus based on the calculated brightness; and
control means for controlling the photographing apparatus so as to perform photographing by using the determined control parameter.

### (Supplementary Note 2)

The control apparatus described in Supplementary note 1, wherein the calculation means calculates the brightness by using pixels in the area of the detection target, corresponding to at least one part constituting the detection target.

### (Supplementary Note 3)

The control apparatus described in Supplementary note 1 or 2, wherein the calculation means calculates the brightness by using pixels in the area of the detection target, corresponding to at least one feature point characterizing the detection target.

### (Supplementary Note 4)

The control apparatus described in Supplementary note 3, wherein when a part of the detection target is shielded, the calculation means calculates the brightness by using pixels corresponding to a feature point other than a feature point located in the shielded part of the detection target.

### (Supplementary Note 5)

The control apparatus described in Supplementary note 3, wherein when a part of the detection target is shielded, the calculation means calculates the brightness by making a weight of pixels corresponding to the feature point located in the shielded part of the detection target smaller than a weight of pixels corresponding to the feature point located in an unshielded part, and then calculating a weighted average of pixel values of pixels corresponding to the feature points.

### (Supplementary Note 6)

The control apparatus described in Supplementary note 3, wherein the calculation means calculates the brightness by preferentially using pixels corresponding to a feature point for a part of the detection target having a high priority over pixels corresponding to a feature point for a part thereof having a low priority, the priorities being set for the parts of the detection target in advance.

### (Supplementary Note 7)

The control apparatus described in Supplementary note 1, wherein the calculation means calculates the brightness by using pixels in an unshielded area included in the area of the detection target.

### (Supplementary Note 8)

The control apparatus described in Supplementary note 1, wherein the calculation means calculates the brightness by using pixels located at a predetermined interval in the area of the detection target.

### (Supplementary Note 9)

The control apparatus described in any one of Supplementary notes 1 to 8, wherein the detection target is a face of a person.

(Supplementary note 10)

A control method comprising:
acquiring an image obtained by photographing a surrounding environment;
performing a process for detecting a detection target from the acquired image;
calculating brightness by using some of pixels in an area of the detection target detected from the image, specified under a predetermined condition;
determining a control parameter used in a photographing apparatus based on the calculated brightness; and
controlling the photographing apparatus so as to perform photographing by using the determined control parameter.

### (Supplementary Note 11)

The control method described in Supplementary note 10, wherein brightness is calculated by using pixels in the area of the detection target, corresponding to at least one part constituting the detection target.

### (Supplementary Note 12)

The control method described in Supplementary note 10 or 11, wherein brightness is calculated by using pixels in the area of the detection target, corresponding to at least one feature point characterizing the detection target.

### (Supplementary Note 13)

The control method described in Supplementary note 12, wherein when a part of the detection target is shielded, brightness is calculated by using pixels corresponding to a feature point other than a feature point located in the shielded part of the detection target.

### (Supplementary Note 14)

The control method described in Supplementary note 12, wherein when a part of the detection target is shielded, brightness is calculated by making a weight of pixels corresponding to the feature point located in the shielded part of the detection target smaller than a weight of pixels corresponding to the feature point located in an unshielded part, and then calculating a weighted average of pixel values of pixels corresponding to the feature point.

### (Supplementary Note 15)

The control method described in Supplementary note 12, wherein brightness is calculated by preferentially using pixels corresponding to a feature point for a part of the detection target having a high priority over pixels corresponding to a feature point for a part thereof having a low priority, the priorities being set for the parts of the detection target in advance.

### (Supplementary Note 16)

The control method described in Supplementary note 10, wherein brightness is calculated by using pixels in an unshielded area included in the area of the detection target.

### (Supplementary Note 17)

The control method described in Supplementary note 10, wherein brightness is calculated by using pixels located at a predetermined interval in the area of the detection target.

### (Supplementary Note 18)

The control method described in any one of Supplementary notes 10 to 17, wherein the detection target is a face of a person.

### (Supplementary Note 19)

A non-transitory computer readable medium storing a program for causing a computer to perform:
a step of acquiring an image obtained by photographing a surrounding environment;
a step of performing a process for detecting a detection target from the acquired image;
a step of calculating brightness by using some of pixels in an area of the detection target detected from the image, specified under a predetermined condition;
a step of determining a control parameter used in a photographing apparatus based on the calculated brightness; and
a step of controlling the photographing apparatus so as to perform photographing by using the determined control parameter.

### REFERENCE SIGNS LIST

1 CONTROL APPARATUS
2 IMAGE ACQUISITION UNIT
4 DETECTION UNIT
6 CALCULATION UNIT
8 DETERMINATION UNIT
10 CONTROL UNIT
20 CONTROL SYSTEM
22 NETWORK
30 PHOTOGRAPHING APPARATUS
100 CONTROL APPARATUS
120 IMAGE ACQUISITION UNIT
130 DETECTION UNIT
140 BRIGHTNESS CALCULATION UNIT
150 CONTROL PARAMETER DETERMINATION UNIT
160 CONTROL UNIT

What is claimed is:

1. A control apparatus comprising:
at least one memory configured to store instructions; and
at least one processor configured to execute the instructions to:
acquire an image obtained by photographing a surrounding environment;
perform a process for detecting a detection target from the acquired image;
calculate brightness by using some of pixels in an area of the detection target detected from the image, specified under a predetermined condition;
determine a control parameter used in a photographing apparatus based on the calculated brightness; and
control the photographing apparatus so as to perform photographing by using the determined control parameter.

2. The control apparatus according to claim 1, wherein the at least one processor is further configured to execute the instructions to calculate the brightness by using pixels in the area of the detection target, corresponding to at least one part constituting the detection target.

3. The control apparatus according to claim 1, wherein the at least one processor is further configured to execute the instructions to calculate the brightness by using pixels in the area of the detection target, corresponding to at least one feature point characterizing the detection target.

4. The control apparatus according to claim 3, wherein when a part of the detection target is shielded, the at least one processor is further configured to execute the instructions to calculate the brightness by using pixels corresponding to a feature point other than a feature point located in the shielded part of the detection target.

5. The control apparatus according to claim 3, wherein when a part of the detection target is shielded, the at least one processor is further configured to execute the instructions to calculate the brightness by making a weight of pixels corresponding to the feature point located in the shielded part of the detection target smaller than a weight of pixels corresponding to the feature point located in an unshielded part, and then calculate a weighted average of pixel values of pixels corresponding to the feature points.

6. The control apparatus according to claim 3, wherein the at least one processor is further configured to execute the instructions to calculate the brightness by preferentially using pixels corresponding to a feature point for a part of the detection target having a high priority over pixels corresponding to a feature point for a part thereof having a low priority, the priorities being set for the parts of the detection target in advance.

7. The control apparatus according to claim 1, wherein the at least one processor is further configured to execute the instructions to calculate the brightness by using pixels in an unshielded area included in the area of the detection target.

8. The control apparatus according to claim 1, wherein the at least one processor is further configured to execute the instructions to calculate the brightness by using pixels located at a predetermined interval in the area of the detection target.

9. The control apparatus according to claim 1, wherein the detection target is a face of a person.

10. A control method comprising:
acquiring an image obtained by photographing a surrounding environment;
performing a process for detecting a detection target from the acquired image;
calculating brightness by using some of pixels in an area of the detection target detected from the image, specified under a predetermined condition;
determining a control parameter used in a photographing apparatus based on the calculated brightness; and
controlling the photographing apparatus so as to perform photographing by using the determined control parameter.

11. The control method according to claim 10, wherein brightness is calculated by using pixels in the area of the detection target, corresponding to at least one part constituting the detection target.

12. The control method according to claim 10, wherein brightness is calculated by using pixels in the area of the detection target, corresponding to at least one feature point characterizing the detection target.

13. The control method according to claim 12, wherein when a part of the detection target is shielded, brightness is calculated by using pixels corresponding to a feature point other than a feature point located in the shielded part of the detection target.

14. The control method according to claim 12, wherein when a part of the detection target is shielded, brightness is calculated by making a weight of pixels corresponding to the feature point located in the shielded part of the detection target smaller than a weight of pixels corresponding to the feature point located in an unshielded part, and then calculating a weighted average of pixel values of pixels corresponding to the feature point.

15. The control method according to claim 12, wherein brightness is calculated by preferentially using pixels corresponding to a feature point for a part of the detection target having a high priority over pixels corresponding to a feature point for a part thereof having a low priority, the priorities being set for the parts of the detection target in advance.

16. The control method according to claim 10, wherein brightness is calculated by using pixels in an unshielded area included in the area of the detection target.

17. The control method according to claim 10, wherein brightness is calculated by using pixels located at a predetermined interval in the area of the detection target.

18. The control method according to claim 10, wherein the detection target is a face of a person.

19. A non-transitory computer readable medium storing a program for causing a computer to perform:
a step of acquiring an image obtained by photographing a surrounding environment;
a step of performing a process for detecting a detection target from the acquired image;
a step of calculating brightness by using some of pixels in an area of the detection target detected from the image, specified under a predetermined condition;
a step of determining a control parameter used in a photographing apparatus based on the calculated brightness; and
a step of controlling the photographing apparatus so as to perform photographing by using the determined control parameter.
